(19) United States
(12) Patent Application Publication
(10) Pub. No.: US 2016/0081393 A1
(43) Pub. Date: Mar. 24, 2016

(54) PERSONAL VAPING DEVICE

(71) Applicant: Alvin Black, Spanish Fork, UT (US)

(72) Inventor: Alvin Black, Spanish Fork, UT (US)

(21) Appl. No.: 14/863,592

(22) Filed: Sep. 24, 2015

Related U.S. Application Data
(60) Provisional application No. 62/054,537, filed on Sep. 24, 2014.

(51) Int. Cl. A24F 47/00; G06F 3/01; H04L 29/08; H05B 3/00

(52) U.S. Cl. CPC A24F 47/008; H05B 3/0014; G06F 3/01; H04L 67/10

(57) ABSTRACT

A personal vaporizer is disclosed. The personal vaporizer comprises a container configured for containing at least one substance and a vaporizer configured for converting the at least one substance into vapor form. Further, personal vaporizer comprises at least one sensor configured for sensing at least one variable associated with at least one component of the personal vaporizer, at least one actuator configured for changing at least one variable associated with at least one component of the personal vaporizer, a communication interface configured for communicating information between the personal vaporizer and an external device, a power source configured for providing power to at least one component of the personal vaporizer and a controller configured for controlling at least one of the at least one sensor and the at least one actuator, wherein the controlling is based on at least one location of the personal vaporizer.

### CROSS-REFERENCE TO RELATED APPLICATIONS

This application claims benefit of U.S. provisional patent application No. 62/054,537 filed on Sep. 24, 2014, which is incorporated herein by reference in its entirety.

### FIELD OF THE INVENTION

Generally, the present disclosure relates to personal vaporizers. More particularly, the present disclosure relates to a personal vaporizer configured to communicate with an external device.

### BACKGROUND

Vaporizers (also known as vaping devices, e-cigarettes or “e-cigs”) have become increasingly popular in the modern world as an alternative to more traditional means of smoking, which, through burning, produce many irritating toxic and carcinogenic by-products. Vaporizers on the other hand utilize liquid solutions usually prepared with vegetable glycerin or propylene glycol base mixed with different additives, such as nicotine and flavors. These liquid solutions are often referred to as “e-liquids.” A vaporizer feeds such a liquid solution to a heating chamber, where the heat results in vaporization of the solution. The created vapors are then inhaled by a person.

Vaporizers are largely used as standalone devices as they do not connect and communicate with any other device. Accordingly, these vaporizers are restricted in their functionality. While some vaporizers may afford a degree of built-in control and monitoring, such as variable voltage control to adjust the power that goes through the heating element and battery voltage monitoring, they do not provide a wider breadth of control and monitoring through connectivity to external systems.

A new and improved vaporizer is desired that collects data, communicates with external devices, and receive instructions.

### SUMMARY

In some embodiments, a personal vaporizer is disclosed. The personal vaporizer comprises a container configured for containing at least one substance and a vaporizer configured for converting the at least one substance into vapor form. Further, personal vaporizer comprises at least one sensor configured for sensing at least one variable associated with at least one component of the personal vaporizer, at least one actuator configured for changing at least one variable associated with at least one component of the personal vaporizer, a communication interface configured for communicating information between the personal vaporizer and an external device, a power source configured for providing power to at least one component of the personal vaporizer and a controller configured for controlling at least one of the at least one sensor and the at least one actuator, wherein the controlling is based on at least one location of the personal vaporizer.

In some other embodiments, a method of managing a personal vaporizer is disclosed. The method comprises communicating information between the personal vaporizer and an external device. The personal vaporizer comprises a container configured for containing at least one substance, a vaporizer configured for converting the at least one substance into vapor form, at least one sensor configured for sensing at least one variable associated with at least one component of the personal vaporizer, at least one actuator configured for changing at least one variable associated with at least one component of the personal vaporizer, a communication interface configured for communicating information with the external device, a power source configured for providing power to at least one component of the personal vaporizer and a controller configured for controlling at least one of the at least one sensor and the at least one actuator, wherein the controlling is based on at least one location of the personal vaporizer.

### BRIEF DESCRIPTION OF DRAWINGS

FIG. 1 illustrates an exemplary environment in which an embodiment of the present disclosure operates.

FIG. 2 is a block diagram of a personal vaporizer, in accordance with an embodiment.

FIG. 3 illustrates a flowchart of a method for managing a personal vaporizer, in accordance with an embodiment.

FIG. 4 illustrates a flowchart of a method for managing a personal vaporizer, in accordance with another embodiment.

FIG. 5 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

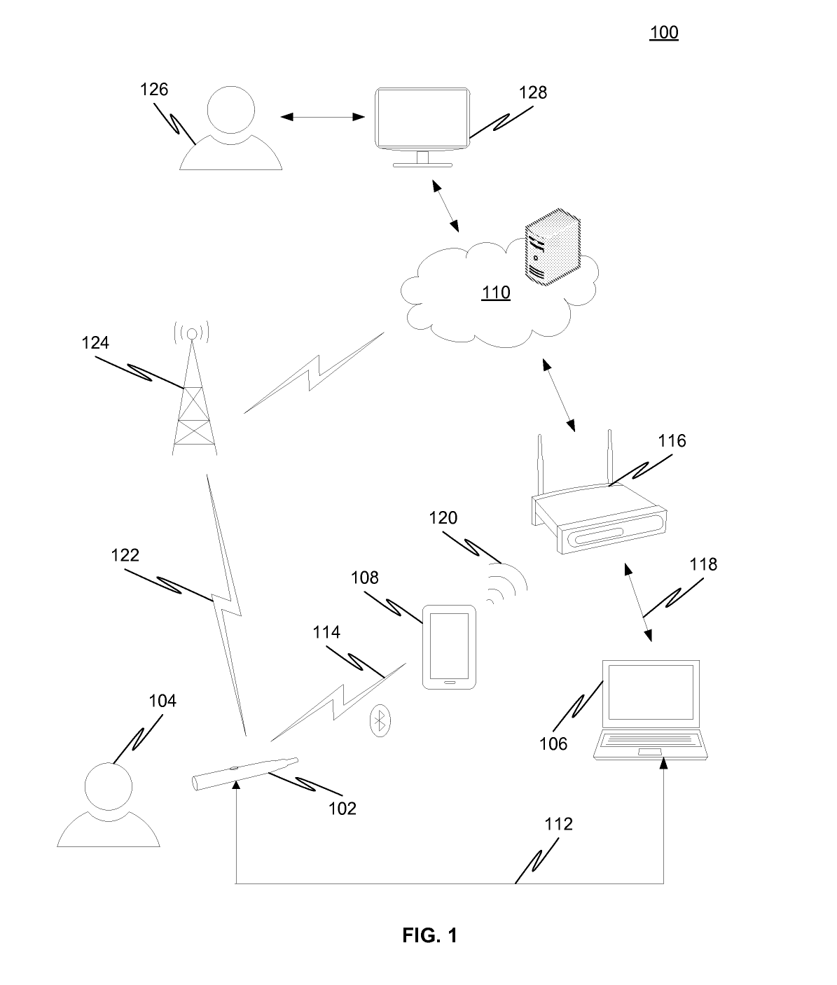

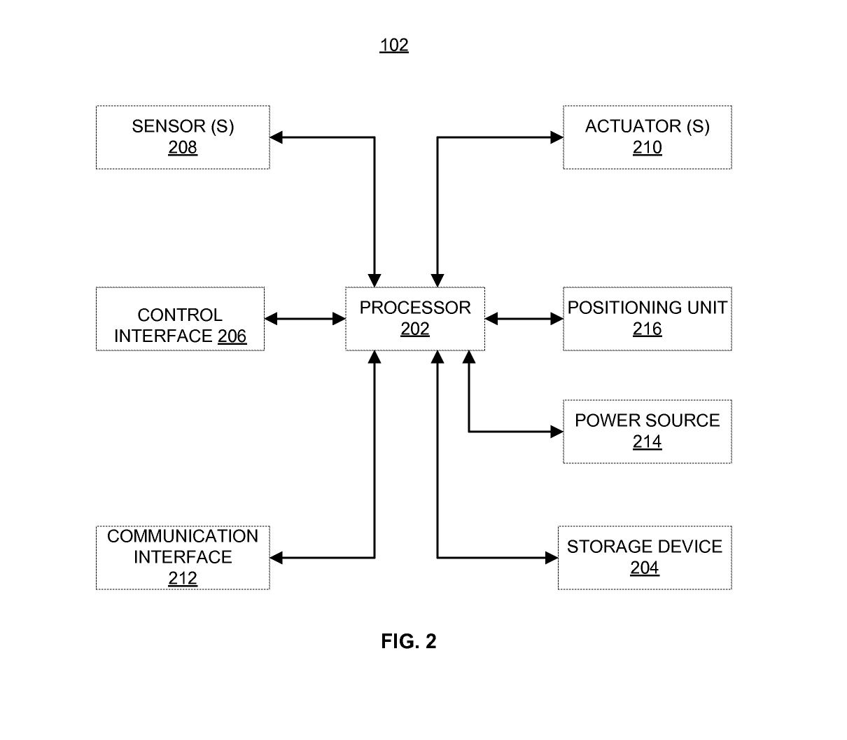

The present disclosure will be further illustrated with examples below. Referring first to FIG. 1 illustrating an exemplary environment 100 in which an embodiment of the present disclosure operates. The environment 100 includes a personal vaporizer 102 being used by a user 104. The personal vaporizer 102 includes a container (not shown) configured to contain one or more substances. The one or more substances may in fluid form. Further, the one or more substances may include nicotine. The personal vaporizer 102 further includes a vaporizer (not shown) configured for converting the one or substances into vapor form. The vaporizer may include a heating element configured for heating the one or more substances for converting the one or more substances to vapor form. The personal vaporizer 102 further includes an opening (not shown) configured for enabling the user 104 to inhale the vapor generated by the vaporizer. The personal vaporizer 102 is explained in further detail in conjunction with FIG. 2 below.

The personal vaporizer 102 is configured to communicate with external devices such as a personal computer 106, a smartphone 108 and a cloud server 110. Further, the personal vaporizer 102 may communicate over a wired connection 112 with the personal computer 106. For example, the personal vaporizer 102 and the personal computer 106 may have USB ports and the wired connection 112 may be established using a mini USB/USB connector cable, such as those commonly used to connect smartphones and tablets to chargers or other devices. The personal vaporizer 102 may communicate over a wireless connection 114 with the smartphone 108. For example, the wireless connection 114 may be a Wi-Fi™ connection or a Bluetooth® connection. Such wired or wireless connections may be either synchronous or asynchronous. Further, they may allow information and commands to flow in either direction between the personal vaporizer 102 and the external device.

The personal computer 106 may be connected to a modem 116 via a wired connection 118. Further, the smartphone 108 may be connected to the modem 116 via a wireless connection 120, such as Wi-Fi™. The modem 116 may be connected to the cloud server 110. The personal vaporizer 102 may communicate with the cloud server 110 via the smartphone 108 and the personal computer 106. Further, the personal vaporizer 102 may communicate directly with the cloud server 110, over a cellular connection 122 via a cell phone tower 124.

A second user 126 may be able to access the cloud server 110 using secure access from a computer 128. The second user 126 may be one of a family member/friend of the user 104, a caregiver, a manufacturer of the personal vaporizer 102, and a government representative. The second user 126 may remotely monitor the data communicated by the personal vaporizer 102 to the cloud server 110. Further, the second user 126 may send instructions to the personal vaporizer 102 via the cloud server 110.

Now, referring to FIG. 2, the personal vaporizer 102 is illustrated in accordance with an embodiment. The personal vaporizer 102 includes one or more processors (for example, a processor 202), a memory (e.g., a storage device 204) and a control interface 206. The personal vaporizer 102 further includes one or more sensors 208, one or more actuators 210, a communication interface 212, a power source 214 and a positioning unit 216. The storage device 204 may be a computer readable medium. The storage device 204 stores instructions that, when executed by the processor 202, causes the processor 202 to process data received from the one or more sensors 208, the one or more actuators 210, the communication interface 212, the power source 214 and the positioning unit 216 in accordance with various embodiments. Specifically, storage device 204 stores instructions that, when executed by the processor 202, causes the processor 202 to control the one or more sensors 208 and the one or more actuators 210. Further, the processor 202 may control the one or more sensors 208 and the one or more actuators 210 based the location of the personal vaporizer 102. Yet further, the processor 202 controls the one or more sensors 208 and the one or more actuators 210 based on the information received through the communication interface 212.

The storage device 204 may also store the data received from the one or more sensors 208, the one or more actuators 210, the communication interface 212, the power source 214 and the positioning unit 216.

The one or more sensors 208 are configured for sensing one or more variables associated with various components of the personal vaporizer 102. For example, a sensor in the one or more sensors 208 may be configured for sensing one or more variables associated with the one or more substances placed in the container of the personal vaporizer 102. Similarly, another sensor in the one or more sensors 208 may be configured for sensing one or more variables associated with inhaling the vapor generated by the vaporizer of the personal vaporizer 102. Yet another sensor in the one or more sensors 208 may be configured for sensing one or more variables associated with the power source 214. In effect, the one or more sensors 208 monitor the controllable components of the personal vaporizer 102, allowing for information to be relayed or acted upon as necessary. The one or more sensors 208 are communicably coupled to the processor 202, allowing the processor 202 to adjust settings of the controllable components of the personal vaporizer 102 based on data provided from the one or more sensors 208.

The one or more actuators 210 are configured for changing one or more variables associated with various components of the personal vaporizer 102. For example, an actuator in the one or more actuators 210 may be configured to close a valve to control the supply of nicotine to the heating element of the vaporizer.

The control interface 206 may include a digital or binary display mechanism as well as buttons or other selection mechanisms integrated with the personal vaporizer 102. The control interface 206 allows the user 104 to execute a number of control instructions. The control interface 206 may also be accessible via the external devices. The control interface 206 may also allow the user 104 to monitor statistics about his or her vaping habits. For example, to help the user 104 track their progress towards a goal such as reduction in nicotine usage or smoking frequency. Alternatively, the user 104 may use an external device to monitor statistics about his or her vaping habits.

The personal vaporizer 102 communicates with an external device via the communication interface 212. The external device may be the personal computer 106, the smartphone 108 and the cloud server 110. Further, the communication interface 212 may connect to social networks to allow automated sharing of goal accomplishments based on device usage. For example, an automated Tweet to a Twitter account indicating that a nicotine reduction goal has been achieved by the user 104.

The power source 214 is configured for providing power to various components of the personal vaporizer 102. The positioning unit 216 is configured for determining a position of the personal vaporizer 102. For example, the positioning unit may be a GPS receiver that obtains the GPS location of the vaporizer. The GPS location may be obtained on a continuous or periodic basis or as selected by the user. The GPS location may additionally be measured in conjunction with the variables measured by the one or more sensors 208. Further, the personal vaporizer 102 may include a timer (not shown) configured for measuring time.

The personal vaporizer 102 also includes identification chips, which may be microchips that store electronically identifiable information that is used to identify specific components to the personal vaporizer 102. The identifiable information includes, but is not limited to, type of a clearomizer or an atomizer, the model of the battery, software version of the software stored in the storage device 204, and hardware version of other components. Further, containers of the personal vaporizer 102 may include identification chips that are used to determine the composition of the stored one or more substances, including identification of the flavors (e.g. “strawberry” or “banana”) and the percentage of nicotine it contains.

The one or more of the processors 202 execute the instructions stored in the storage device 204. An external device may send modified or updated instructions to be stored in the storage device 204 to override previously stored instructions.

Further, one or more of the processor 202, the storage device 204, the control interface 206, the one or more sensors 208, the one or more actuators 210, the communication interface 212, the power source 214 and the positioning unit 216 may be built in to the personal vaporizer 102 or it may be provided as retrofit extension to an existing vaporizer.

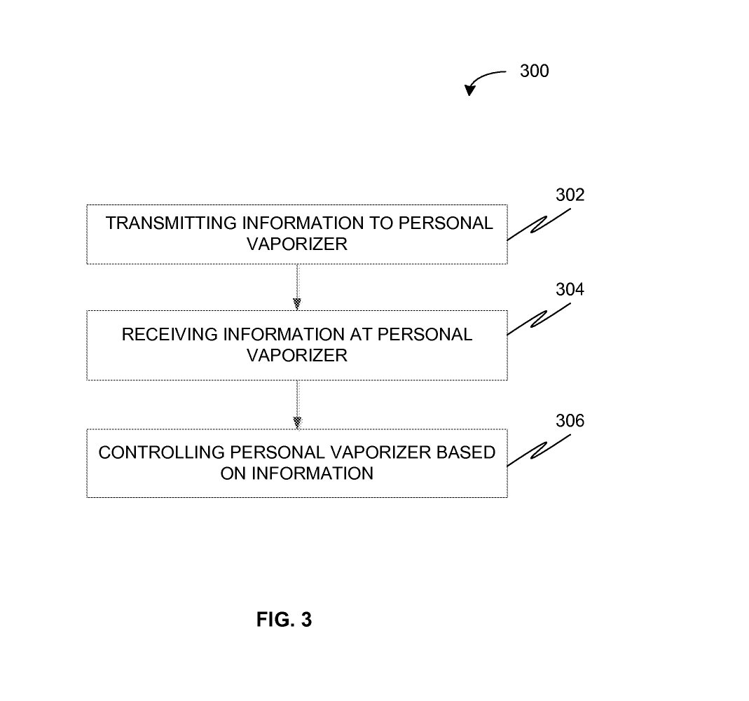

FIG. 3 illustrates a flowchart of a method 300 for managing the personal vaporizer 102, in accordance with an embodiment. At 302, an external device transmits information to the personal vaporizer 102. The external device may be the personal computer 106, the smartphone 108 and the cloud server 110. Next, at 304, the personal vaporizer 102 receives the transmitted information. Finally, at 306, the received information is used to control the personal vaporizer 102.

The received information may include recommendations for maintenance of the personal vaporizer 102 or replacement of a component of the personal vaporizer 102, such as a wick, a battery, or the one or more substances to be vaporized. A visual and/or an auditory signal may be activated to inform the user 104 to replace the one or more components of the personal vaporizer 102.

Further, the received information may include control settings for the personal vaporizer 102, such as the voltage levels, the amount of flavors and the amount of nicotine being delivered through the opening to the user 104. Therefore, the control settings may be used to ration or adjust nicotine delivery levels throughout the day based on specific time-of-day models. Further, the control settings may operate the personal vaporizer 102 according to a designated program, such as a nicotine reduction program which phases out nicotine delivery over a vaping session or over a period of time.

Yet further, the received information may include control settings to prohibit usage of the personal vaporizer 102 during certain times of day, or in conjunction with certain events, or in certain physical locations or to control the frequency or duration of use of the personal vaporizer 102. Therefore, the method 300 may be used to automatically enforce no-vaping policies within certain buildings based on a combination of the location of the personal vaporizer 102 and/or databases of vaping restrictions tied to certain locations and/or location-based broadcast signals. For example, a broadcast signal within a room or building may indicate the vaping policy or vaping constraints set for that room or building. Moreover, the received information may include control settings to prohibit usage of the vaporizer in the event that it is lost or stolen and may also help to detect a lost vaporizer by obtaining the location of the personal vaporizer 102.

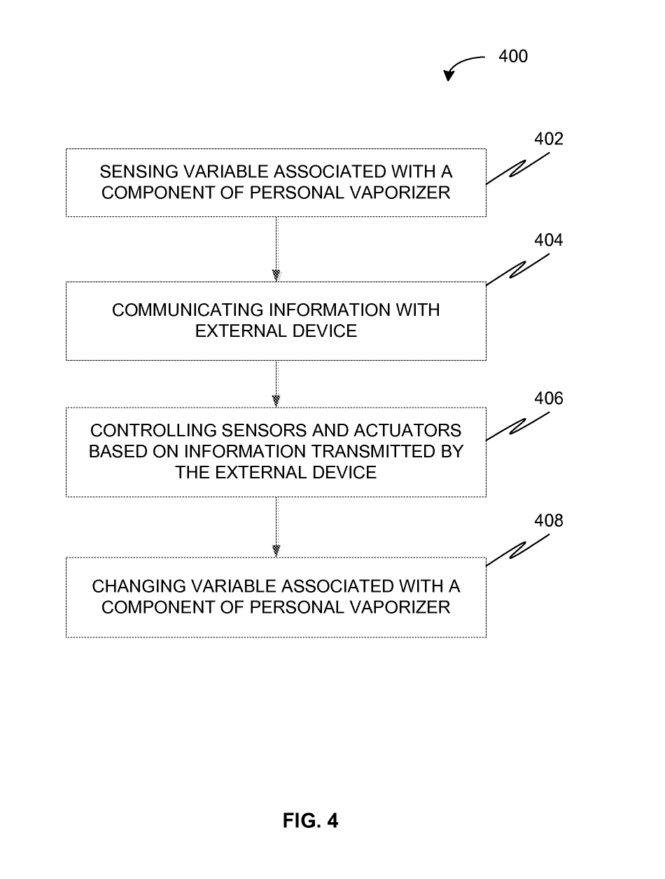

Now referring to FIG. 4, a method 400 is illustrated for managing the personal vaporizer 102, in accordance with another embodiment. At 402, the one or more sensors 208 sense one or more variables associated with various components of the personal vaporizer 102 to obtain sensed data. For example, a sensor may measure variable data for each puff or drag on the personal vaporizer 102, including the date and time each drag was initiated by the user 104, the total number of drags up to the current drag, duration of a drag, strength (a measure of airflow) of a drag, any settings on the vaporizer that were set at the time of a drag (such as the voltage being supplied to the heating element), remaining battery voltages, the volume of fluids in the container(s), temperature of the heating element(s), and potentially a number of other variables about the flavor or amount of flavor that was delivered during a drag.

Further, the one or more sensors 208 may also measure variable data which may not be directly related to specific puffs or drags on the personal vaporizer 102, including identification of the specific attachments to the personal vaporizer 102 (for example, type of clearomizer installed, model of battery, etc.), time since the replacement of certain components (e.g., wicks, battery, juices, etc.), volume of fluids in the container(s), settings on the personal vaporizer 102 (e.g., voltage settings), date and time when the personal vaporizer 102 was switched on/off, and potentially a number of other variables.

At 404, the personal vaporizer 102 communicates information with an external device, including one or more of the personal computer 106, the smartphone 108 and the cloud server 110. The personal vaporizer 102 may send the sensed data to the external device. The external device may process the sensed data and transmit information back to the personal vaporizer 102. The transmitted information by the external device has been explained in further detail in conjunction with FIG. 3 above. Further, the sensed data may be processed at the personal vaporizer 102 based on instructions stored in the storage device 204 that, when executed by the processor 202, causes the processor 202 to process data.

Thereafter, at 406, the processor 202 is used to control one or more of sensors and actuators based on information transmitted by the external device. The processor 202 may generate control signals for the one or more actuators 210 available with various controllable components of the personal vaporizer 102. In order to generate the control signals, the processor 202 uses the data provided from by the one or more sensors 208, information provided by the identification chips, and location information from the positioning unit 216. Information gathered or control instructions indicated hereinafter may require the sensor system, identification chips, GPS receiver, and control interface to be built into a vaporizer during manufacturing.

Finally, at 408, the control signals change one or more variables associated with one or more controllable components of the personal vaporizer 102. For example, the control signals may be used to open or close valves (actuators) that supply fluids to the heating element(s) in the vaporizer. Further, the control signals may be used to adjust the amount of voltage (actuator) supplied to the heating element of the vaporizer.

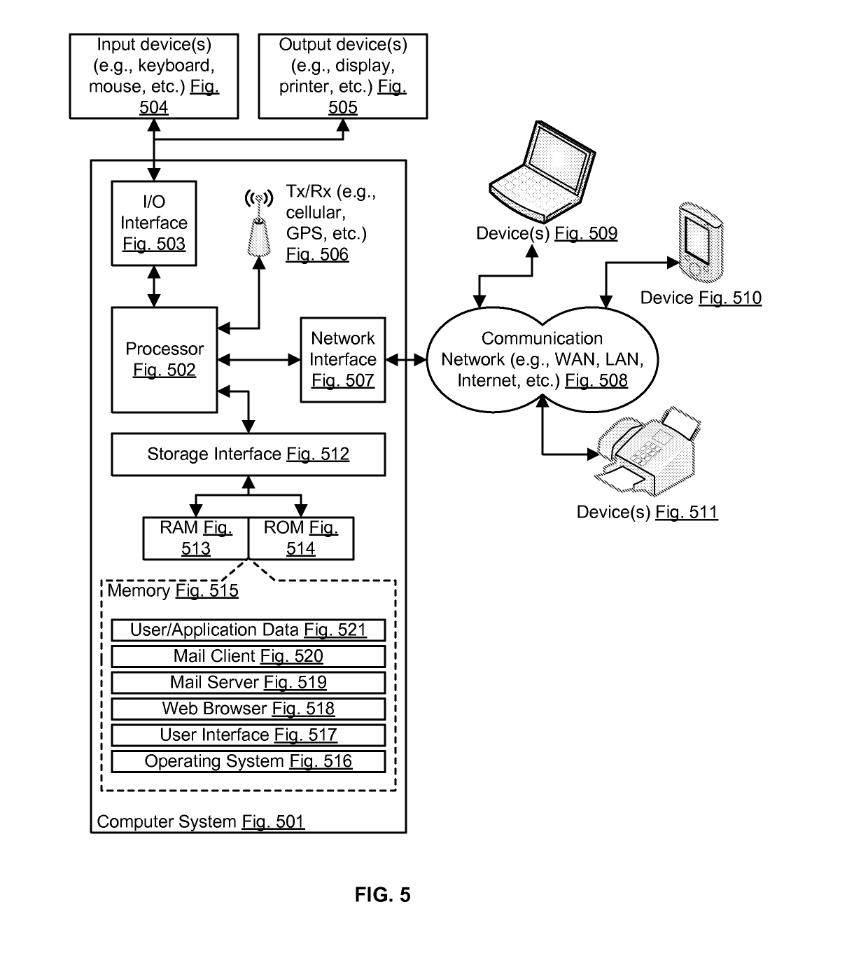

Referring now to FIG. 5, a block diagram of an exemplary computer system 501 for implementing embodiments consistent with the present disclosure is illustrated. Variations of computer system 501 may be used for implementing the personal vaporizer 102 (refer FIG. 2). Computer system 501 may comprise a central processing unit (“CPU” or “processor”) 502. Processor 502 may be the processor 202. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 515 may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The present disclosure provides a smart personal vaporizer or a smart extension to an existing personal vaporizer that has mechanisms to communicably connect a processor or other controller(s) on the vaporizer to an external device. Accordingly, the present disclosure allows a high degree of control of the personal vaporizer via external devices.

It is especially useful for the purposes of reducing dependency on nicotine or even pursuing total smoking cessation.

It is intended that the disclosure and examples be considered as exemplary only, with a true scope and spirit of disclosed embodiments being indicated by the following claims.

We claim:

1. A personal vaporizer comprising:
a container configured for containing at least one substance;
a vaporizer configured for converting the at least one substance into vapor form;
at least one sensor configured for sensing at least one variable associated with at least one component of the personal vaporizer;
at least one actuator configured for changing at least one variable associated with at least one component of the personal vaporizer;
a communication interface configured for communicating information between the personal vaporizer and an external device;
a power source configured for providing power to at least one component of the personal vaporizer; and
a controller configured for controlling at least one of the at least one sensor and the at least one actuator, wherein the controlling is based on at least one location of the personal vaporizer.

2. The personal vaporizer of claim 1, wherein the at least one substance is in fluid form, wherein the at least one substance comprises nicotine.

3. The personal vaporizer of claim 1, wherein the vaporizer comprises a heating element configured for heating the at least one substance for converting the at least one substance to vapor form.

4. The personal vaporizer of claim 1, wherein the at least one sensor is configured for sensing at least one variable associated with the at least one substance.

5. The personal vaporizer of claim 1 further comprising at least one opening configured for enabling a user to inhale the vapor form of the at least one substance, wherein the at least one sensor is configured for sensing at least one variable associated with inhaling the vapor form of the at least one substance.

6. The personal vaporizer of claim 1 further comprising a timer configured for measuring time.

7. The personal vaporizer of claim 1 further comprising a positioning unit configured for determining a position of the personal vaporizer.

8. The personal vaporizer of claim 1, wherein the at least one sensor is configured for sensing at least one variable associated with the power source.

9. The personal vaporizer of claim 1 further comprising a storage device configured for storing information based on sensing the at least one variable associated with at least one component of the personal vaporizer.

10. The personal vaporizer of claim 1, wherein controlling at least one of the at least one sensor and the at least one actuator is based on information received through the communication interface.

11. A method of managing a personal vaporizer, the method comprising communicating information between the personal vaporizer and an external device, wherein the personal vaporizer comprises:
a container configured for containing at least one substance;
a vaporizer configured for converting the at least one substance into vapor form;
at least one sensor configured for sensing at least one variable associated with at least one component of the personal vaporizer;
at least one actuator configured for changing at least one variable associated with at least one component of the personal vaporizer;
a communication interface configured for communicating information with the external device;
a power source configured for providing power to at least one component of the personal vaporizer; and
a controller configured for controlling at least one of the at least one sensor and the at least one actuator, wherein the controlling is based on at least one location of the personal vaporizer.

12. The method of claim 11, wherein the at least one substance is in fluid form, wherein the at least one substance comprises nicotine.

13. The method of claim 11, wherein the vaporizer comprises a heating element configured for heating the at least one substance for converting the at least one substance to vapor form.

14. The method of claim 11, wherein the at least one sensor is configured for sensing at least one variable associated with the at least one substance.

15. The method of claim 11, wherein the personal vaporizer further comprises at least one opening configured for enabling a user to inhale the vapor form of the at least one substance, wherein the at least one sensor is configured for sensing at least one variable associated with inhaling the vapor form of the at least one substance.

16. The method of claim 11, wherein the personal vaporizer further comprises a timer configured for measuring time.

17. The method of claim 11, wherein the personal vaporizer further comprises a positioning unit configured for determining a position of the method.

18. The method of claim 11, wherein the at least one sensor is configured for sensing at least one variable associated with the power source.

19. The method of claim 11, wherein the personal vaporizer further comprises a storage device configured for storing information based on sensing the at least one variable associated with at least one component of the method.

20. The method of claim 11, wherein controlling at least one of the at least one sensor and the at least one actuator is based on information transmitted by the external device.
